(19) United States
(12) Patent Application Publication
(10) Pub. No.: US 2021/0396174 A1
(43) Pub. Date: Dec. 23, 2021

(54) CRANKTRAIN PHASE ADJUSTER FOR VARIABLE COMPRESSION RATIO

(71) Applicant: Schaeffler Technologies AG & Co. KG, Herzogenaurach (DE)

(72) Inventor: Nicholas Hrusch, Wooster, OH (US)

(73) Assignee: Schaeffler Technologies AG & Co. KG, Herzogenaurach (DE)

(21) Appl. No.: 17/350,245

(22) Filed: Jun. 17, 2021

Related U.S. Application Data
(60) Provisional application No. 63/041,314, filed on Jun. 19, 2020.

(51) Int. Cl. F02B 75/04; F01L 1/344

(52) U.S. Cl. CPC F02B 75/047; F01L 2001/34426; F01L 1/3442; F01L 1/34403

(57) ABSTRACT

A phase adjuster is disclosed herein that generally includes multiple stamped components and limits threaded connections between components. According to one aspect, this configuration provides a cost-effective arrangement in which a drive nut can adjust a phase between an input gear and an output gear.

### INCORPORATION BY REFERENCE

This application claims priority to U.S. Provisional Application No. 63/041,314, which was filed on Jun. 19, 2020, and is incorporated herein by reference in its entirety.

### TECHNICAL FIELD

This disclosure is generally related to a cranktrain phase adjuster that can vary a compression ratio of an internal combustion (IC) engine.

### BACKGROUND

Variable compression ratio (VCR) adjustment in IC engines is generally used in order to achieve greater efficiency and improved fuel consumption than an engine with a fixed compression ratio. VCR adjustment systems can rely on a variety of structures and configurations to vary the compression ratio.

Known VCR adjustment systems are typically complicated to integrate with the engine components or require significant space to be installed. Additionally, VCR adjustment systems typically include parts that include threaded engagement interfaces, which require time-consuming assembly and are expensive.

It would be desirable to provide an affordable and compact phase adjuster assembly for a cranktrain to implement VCR in an IC engine.

### SUMMARY

In one aspect, a phase adjuster for an internal combustion engine is disclosed. The phase adjuster can include an input gear assembly having an input gear threading and a base body. In one aspect, a drive plate is provided that includes a first radially extending flange connected to the base body. The drive plate has an axially extending portion arranged radially inward from the base body, and the axially extending portion includes a spline configured to transmit torque to a drive nut. In one aspect, a support plate is provided that includes a second radially extending flange connected to the base body. At least one first fastener connects the base body, the first radially extending flange, and the second radially extending flange to each other. The drive plate and the support plate are preferably formed from stamped sheet metal. The drive plate further comprises a stop element that is configured to limit axial movement of the drive nut, in one aspect.

The drive nut includes a groove on a radially outer surface configured to engage with a piston assembly. The piston assembly includes a piston plate having a protrusion configured to engage with the groove on the drive nut to provide a non-threaded connection between the piston assembly and the drive nut. The piston plate is also formed from stamped sheet metal.

An output assembly is also disclosed herein that includes a first output housing and a second output housing connected via at least one fastener. An output gear is arranged radially inside of the second output housing.

The input gear assembly also includes an input housing supported on the base body via a first bearing and a second bearing. The first bearing is axially supported against a shoulder of the base body, and the second bearing is a thrust bearing engaging an axial end face of the base body.

A seal plate can be provided that is fixed to the input housing. The seal plate is formed from stamped sheet metal and partially defines a hydraulic fluid chamber. A seal can be arranged between the seal plate and the piston plate. An oil control valve (OCV) housing assembly is fixed to the seal plate and the input housing via at least one fastener.

In another aspect, the phase adjuster includes an input gear and an output gear, a drive plate including a spline, and a drive nut configured to transmit torque from the input gear to an output gear via engagement with the spline of the drive plate. The spline of the drive plate is configured to limit axial movement of the drive nut. The drive nut is engaged with a piston plate via a radial protrusion formed on the piston plate, in one aspect.

Additional embodiments described below and in the claims.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a perspective view of one aspect of a phase adjuster.

FIG. 2 is another perspective view of the phase adjuster of FIG. 1.

FIG. 3 is a cross-sectional view of the phase adjuster along line A-A of FIG. 1.

FIG. 4A is a perspective view of an output assembly for the phase adjuster.

FIG. 4B is a cross-sectional view of the output assembly of FIG. 4A.

FIG. 5A is a perspective view of an output housing assembly for the phase adjuster.

FIG. 5B is a cross-sectional view of the output housing assembly of FIG. 5A.

FIG. 6A is a perspective view of an input gear assembly for the phase adjuster.

FIG. 6B is a cross-sectional view of the input gear assembly of FIG. 6A.

FIG. 6C is a perspective view of a stop element.

FIG. 6D is another view of the stop element of FIG. 6C.

FIG. 7A is a perspective view of an input housing assembly for the phase adjuster.

FIG. 7B is a cross-sectional view of the input housing assembly of FIG. 7A.

FIG. 8A is a perspective view of a piston assembly for the phase adjuster.

FIG. 8B is a cross-sectional view of the piston assembly of FIG. 8A.

FIG. 9A is a first perspective view of an oil control valve housing assembly for the phase adjuster.

FIG. 9B is a second perspective view of the oil control valve housing assembly for the phase adjuster.

FIG. 10A is a first cross-sectional view of the oil control valve housing assembly of FIG. 9A.

FIG. 10B is a second cross-sectional view of the oil control valve housing assembly of FIG. 9A.

FIG. 11 is a schematic diagram illustrating the phase adjuster relative as implemented in a cranktrain.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. This terminology includes the words specifically noted above, derivatives thereof and words of similar import.

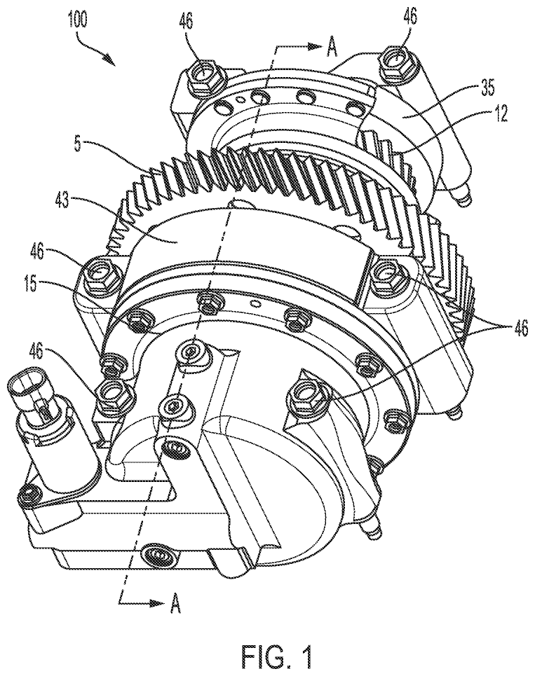

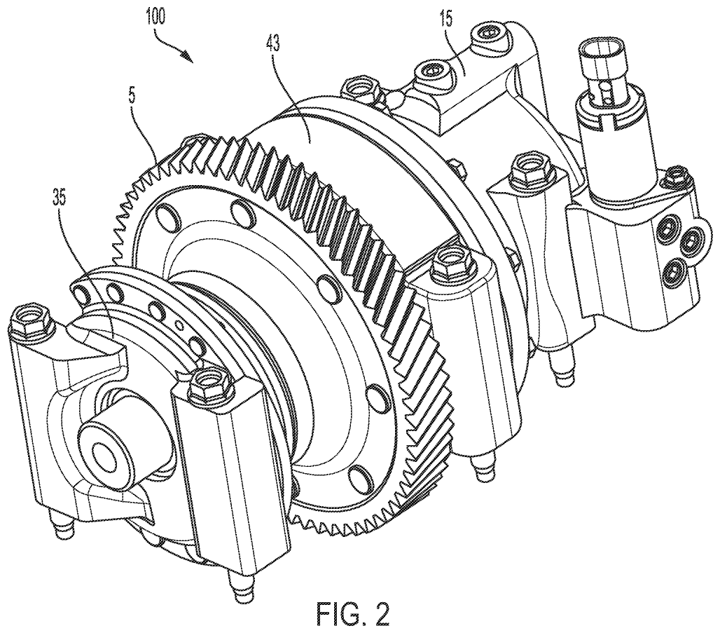

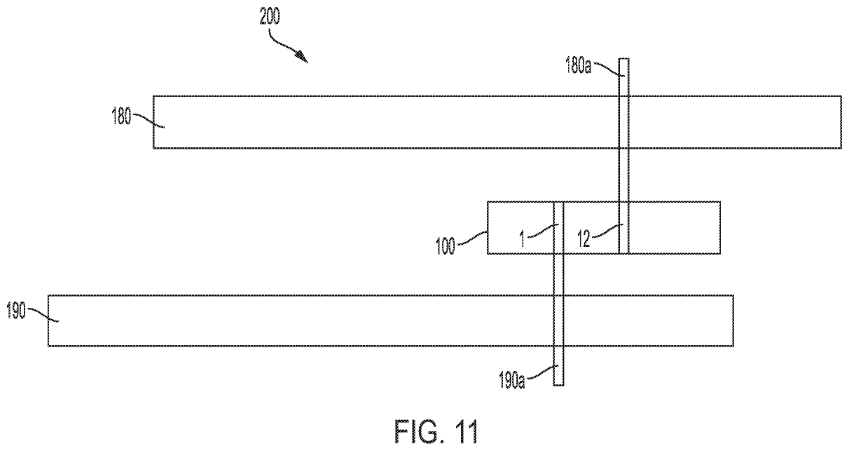

FIGS. 1 and 2 are perspective views of a phase adjuster 100. The phase adjuster 100 can be used in internal combustion engines. More specifically, the phase adjuster 100 can be implemented with a cranktrain 200. A schematic diagram is shown in FIG. 11 that shows the phase adjuster 100 installed relative to a cranktrain 200 including a crankshaft 190, and an eccentric shaft 180. The phase adjuster 100 is generally configured to adjust phasing between the crankshaft 190 and the eccentric shaft 180. FIG. 11 is a schematic drawing and the exact positioning of components relative to each other can vary. The phase adjuster 100 is operatively connected to both the crankshaft 190 and the eccentric shaft 180. This connection or interface between the phase adjuster 100 and the crankshaft 190 and eccentric shaft 180 can be achieved in a variety of ways. Additionally, the phase adjuster 100 can be arranged between different driving components and driven components besides a crankshaft and an eccentric shaft. In one aspect, the phase adjuster 100 has a gear train configured to operatively connect the crankshaft 190 to the eccentric shaft 180. The gear train can comprise gears 1, 12, 180a, 190a which are shown in FIG. 11 for illustrative purposes. The ratio and sizing of the gears 1, 12, 180a, 190a can vary. Other driving engagements can be provided.

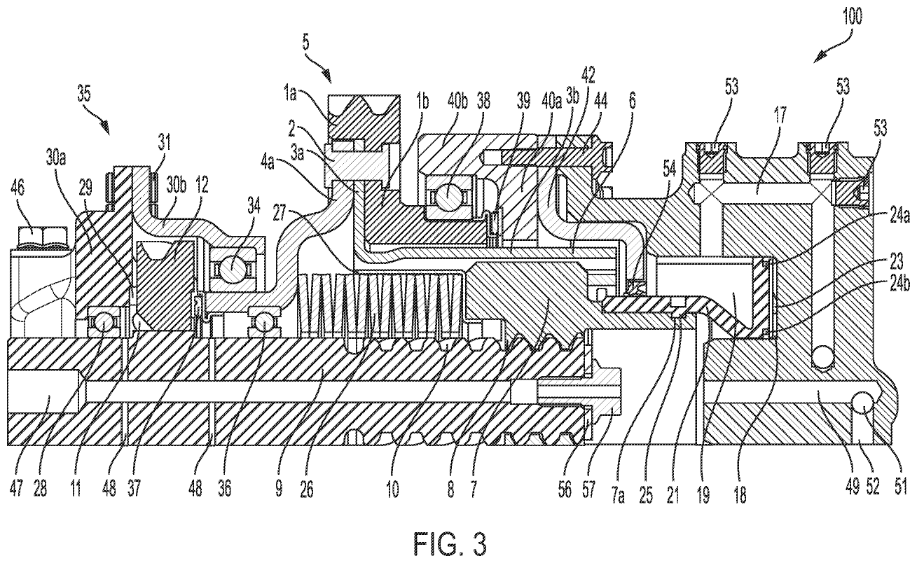

FIG. 3 is a cross-sectional view taken along line A-A from FIG. 1. As shown in FIG. 3, torque or power input from an internal combustion engine, electric motor, or any other input source enters the phase adjuster 100 through an input gear 1. In one aspect, the input gear 1 can be in driving engagement with a crankshaft. One of ordinary skill in the art would understand from the present disclosure that other driving arrangements can be provided.

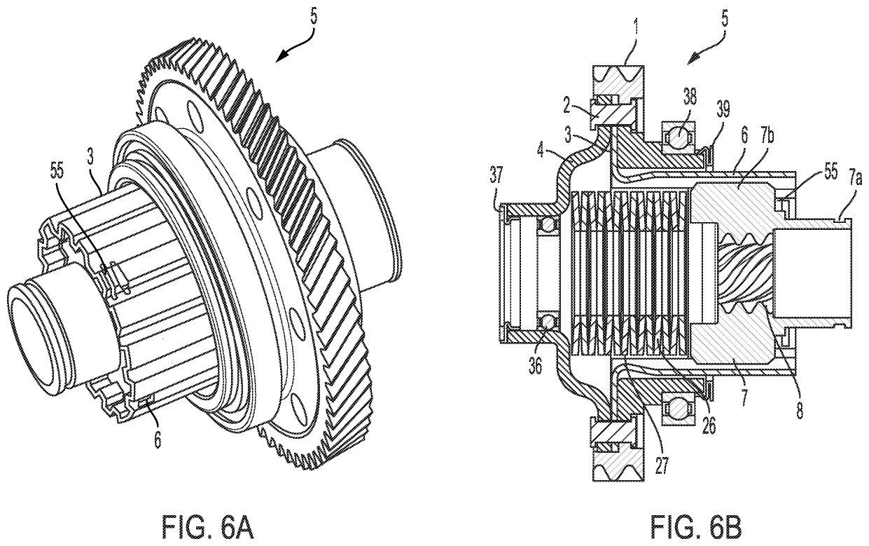

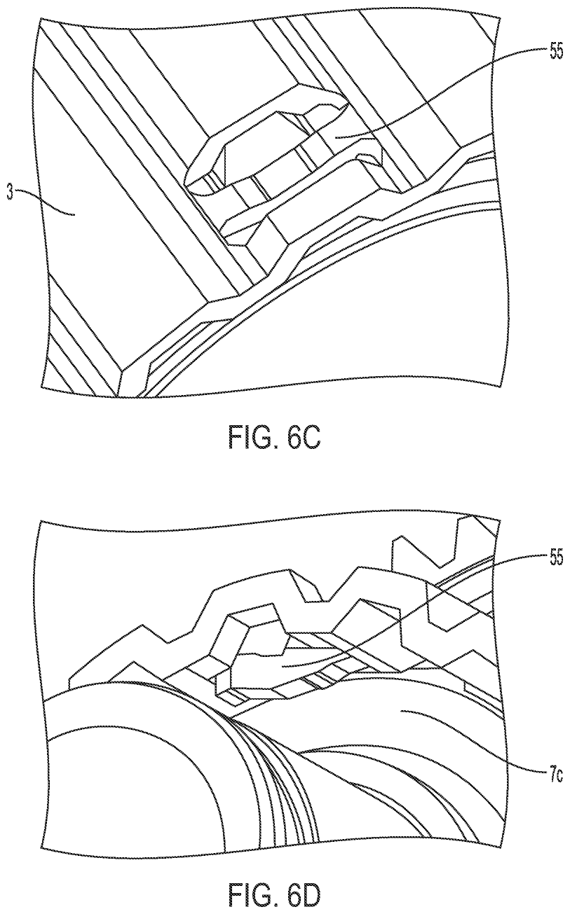

The input gear 1 is generally part of an input gear assembly 5. The input gear 1 includes an input gear threading 1a and a base body 1b. The input gear 1 is secured to a drive plate 3 and a support plate 4 via at least one fastener 2. In one aspect, the at least one fastener 2 includes a plurality of rivets. Other types of fastening means can be used. The input gear assembly 5 is shown in more detail FIGS. 6A and 6B.

In one aspect, the drive plate 3 and the support plate 4 are formed from stamping. Specifically, the drive plate 3 and the support plate 4 are formed from stamped sheet metal, in one aspect. This provides for a more affordable and cost-effective input configuration.

The drive plate 3 includes a radially extending flange 3a connected to the base body 1b. The drive plate 3 also includes an axially extending portion 3b arranged radially inward from the base body 1b. The support plate 4 includes a radially extending flange 4a that is connected to the base body 1b of the input gear 1. As shown in FIG. 3, the at least one fastener 2 is configured to connect the base body 1b, the radially extending flange 3a of the drive plate 3, and the radially extending flange 4a of the support plate 4 as a singly unitary component.

As shown in more detail in FIG. 6A, the drive plate 3 includes an integrally formed spline 6, which is configured to transmit engine torque to a drive nut 7. The spline 6 is formed on the axially extending portion 3b of the drive plate 3. The drive plate 3 is also configured to permit axial motion of the drive nut 7 along the length of the spline 6. The spline 6 can easily be formed via deformation of the drive plate 3 due to it being formed from stamped sheet metal.

As shown in FIGS. 3 and 6B, the drive nut 7 has an internal helical gear 8 on a radially inner surface that is configured to transmit engine torque into an output shaft 9. The output shaft 9 likewise includes an external helical gear 10 configured to mate with the helical gear 8 of the drive nut 7.

At least one stop element 55 can be provided on the drive plate 3 that is configured to axially secure the drive plate 3 with the drive nut 7, as shown in FIGS. 6C and 6D. In one aspect, the stop element 55 comprises a pocket, slot, or other feature having an enclosure dimensioned to receive a portion of the drive nut 7. In one aspect, a back or rear edge 7c of the drive nut 7 is engaged with the stop element 55.

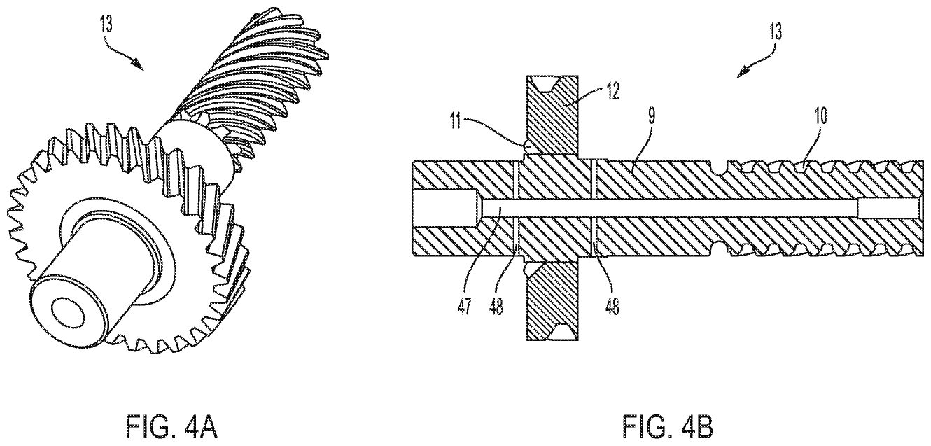

As shown in at least FIGS. 4A and 4B, the external helical gear 10 that is configured to engage with the drive nut 7 is formed on a terminal axial end of the shaft 9. In one aspect, the output shaft 9 is press fit and secured by a weld (i.e. connection interface 11) to an output gear 12 to form an eccentric output assembly 13, as shown in FIGS. 4A and 4B. The output gear 12 is formed separately from the output shaft 9, in one aspect. The output gear 12 is configured to transmit torque out of the phase adjuster 100, such as to the eccentric shaft 180. Additional details of the output shaft 9 are provided herein.

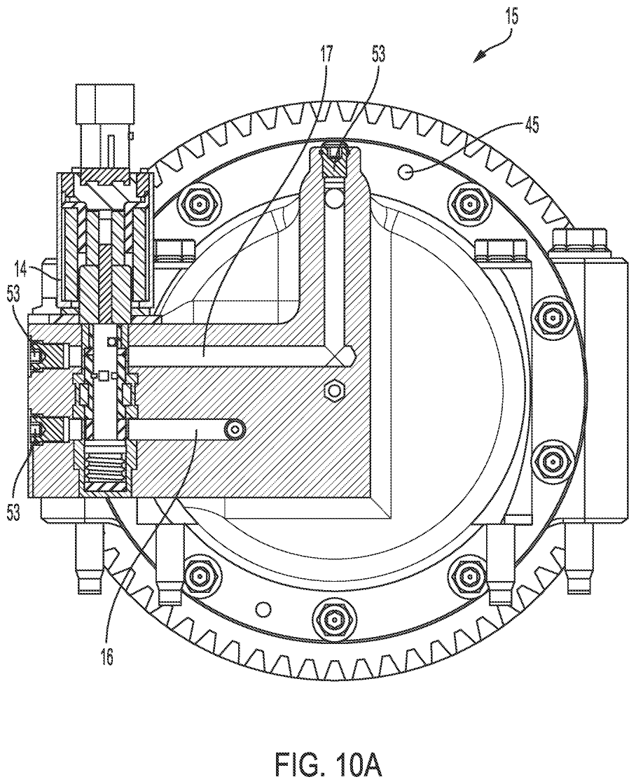

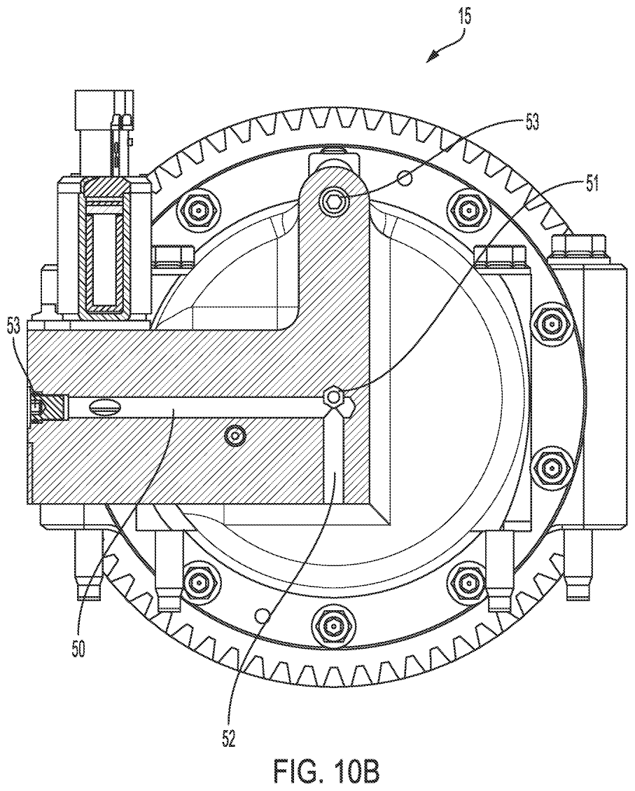

FIGS. 10A and 10B provide details regarding an oil control valve (OCV) 14. In one aspect, the OCV 14 is mounted in an OCV housing assembly 15, and is configured to maintain a pressure balance between an advance port 16 and a retard port 17. The advance port 16 is connected to an advance oil chamber 18 and the retard port 17 is connected to a retard oil chamber 19, as shown in FIG. 3. These two chambers 18, 19 are separated by a piston assembly 20.

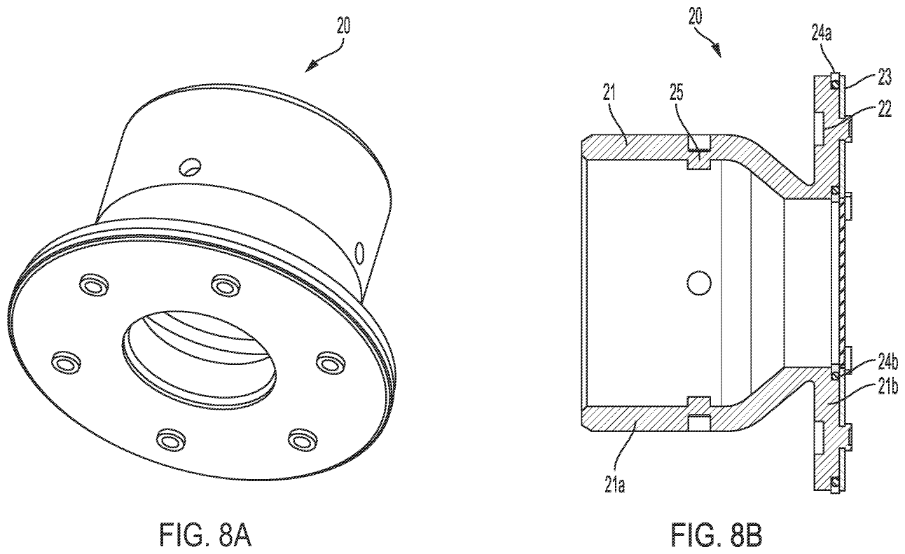

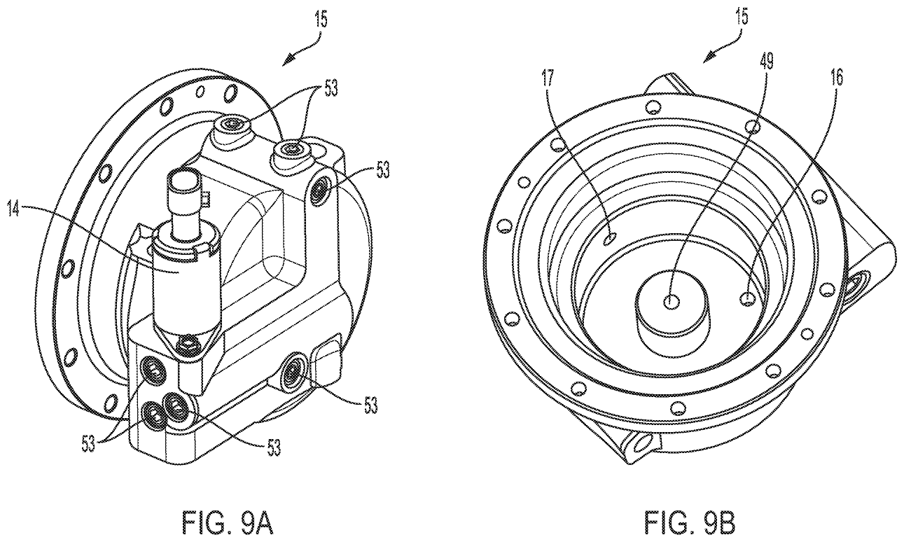

Additional details of the piston assembly 20 are shown in FIGS. 8A and 8B. The piston assembly 20 can include a piston plate 21 that generally divides the wo chambers 18, 19. In one aspect, the piston plate 21 is formed from stamped sheet metal. The piston plate 21 is secured to a clip seal plate 23 via at least one fastener 22. In one aspect, the at least one fastener 22 includes a plurality of rivets. In one aspect, the rivets are formed from the same material as the piston plate 21 itself (i.e. extruded rivets). In another aspect, the rivets 22 are separately formed. At least one seal 24 is arranged between the piston plate 21 and the clip seal plate 23. The piston plate 21 generally includes an axially extending flange 21a and a radially extending flange 21b. As shown in FIG. 8B, the axially extending flange 21a includes a protrusion 25 configured to engage with the drive nut 7. The radially extending flange 21b includes an interface surface configured to engage with the clip seal plate 23 and the at least one seal 24. The at least one seal 24 ensures that the chambers 18, 19 remain separated and sealed from each other. As shown in FIG. 8B, the at least one seal 24 can include a radially outer seal 24a and a radially inner seal 24h, both of which are secured between the piston plate 21 and the clip seal plate 23.

To adjust a phase of the output gear 12 relative to the input gear 1, the OCV 14 provides hydraulic fluid pressure to either the advance or retard ports 16, 17 causing a higher pressure on one side of the piston assembly 20 (i.e. in either one of the chambers 18, 19), which causes the piston plate 21 to move in that direction.

The piston assembly 20, and more specifically the piston plate 21, is connected to an axial end of the drive nut 7 via the protrusion 25 engaging within a groove 7a formed on the drive nut 7, and thus allowing the hydraulic pressure force to be transmitted in either direction into the drive nut 7. In one aspect, the groove 7a is formed on a radially outer surface of the drive nut 7. The groove 7a can include a single indentation or recess. The connection between the piston assembly 20 and the drive nut 7 is provided without any threaded connections, which simplifies the machining and formation of the respective portions required to connect the drive nut 7 with the piston assembly 20. Formation of the protrusion 25 only requires a simple deformation process in which the protrusion 25 is deformed radially inward. One of ordinary skill in the art would understand that the protrusion 25 could also be deformed radially outward to engage with a groove 7a formed on a radially inner surface of the drive nut 7.

As shown in FIG. 6B, the drive nut 7 includes a radially outer spline 7b that mates with the spline 6 of the drive plate 3. As the drive nut 7 is pushed via movement of the piston plate 21, the drive nut 7 imparts a force on the output shaft 9 through the helical gear 8. The contact between the helical gear 8 and the helical gear 10 causes a twisting force to develop on the output shaft 9 which rotates the output shaft 9 relative to the drive nut 7, and thus relative to the input gear 1.

As shown in more detail in FIG. 6B, a spring 26 is contained within a retainer 27 that compresses between the drive nut 7 on a first axial side and the support plate 4 on a second, opposite axial side. The spring 26 provides an opposing force to the piston assembly 20 to ensure the piston assembly 20 is biased in the retard direction. Based on this configuration, the default condition is set to a maximum compression ratio. Due to spring 26, less pressure bias is required to retard the piston assembly 20 as compared to advancing the piston assembly 20. In one aspect, the spring 26 opposes the axial force generated by the torque actin through the helical gears on the drive nut and output shaft 9. As torque increases, the force or travel of the spring also increases. Accordingly, the spring 26 effectively operates to balance the force such that a certain phasing position for a given input torque is maintained. The hydraulic force therefore either adds or subtracts from this force balance to bias the system one way or another, to advance or retard depending on the different phasing position. One of ordinary skill in the art would understand that other configurations may be implemented relative to the piston assembly 20.

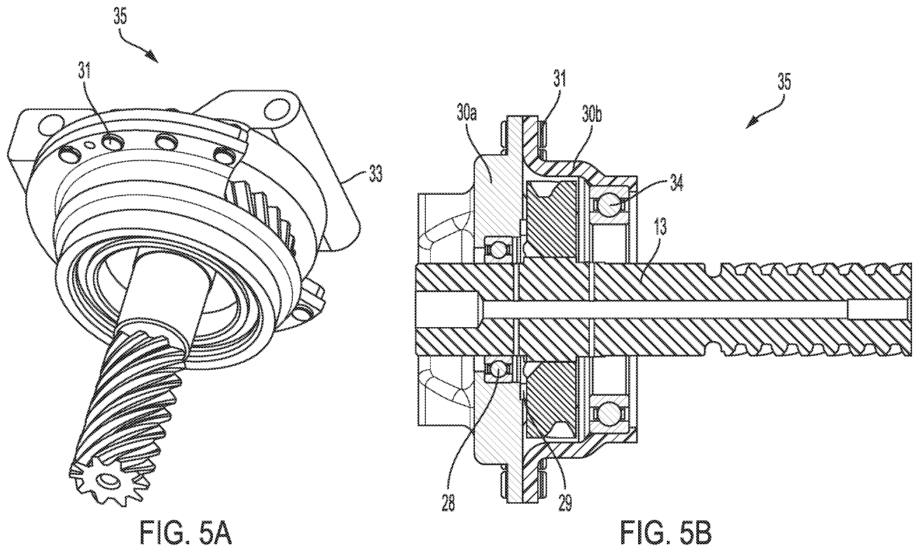

As shown in more detail in FIG. 5B, the eccentric output assembly 13, which includes the output shaft 9 and the output gear 12, is generally supported on a first bearing 28 and a thrust washer 29 relative to an output housing 30a, 30b. The output housing 30a, 30b can be comprised of a first output housing 30a and a second output housing 30b. As shown in FIG. 5B, the output gear 12 is arranged entirely radially inside of the second output housing 30b. The eccentric output assembly 13 and both output housings 30a, 30b together form an output housing assembly 35.

As shown in FIG. 5B, the first bearing 28 is supported between the first output housing 30a and the output shaft 9, and the thrust bearing 29 is supported between the first output housing 30a and the output gear 12. The first and second output housings 30a, 30b are secured to each other via at least one fastener 31. In one aspect, the at least one fastener 31 includes a plurality of rivets, as shown in FIG. 5A.

In one aspect, the second output housing 30b is a stamped sheet metal. As shown in FIG. 5A, an opening 33, such as a slot or window, can be defined on the second output housing 30b. The opening 33 is configured to allow a gear connection to the output gear 12.

A series of bearings, such as bearings 34, 36, 37, 38, 39, etc., are provided in one aspect to provide varying support configurations in both the radial and axial direction. While these bearings may be illustrated as spherical ball bearings or thrust bearings in specific locations in the drawings, one of ordinary skill in the art would understand that the exact shape, type, location, and/or orientation of these bearings can vary. A bearing 34 can be arranged between an axially extending flange of the second output housing 30b and the support plate 4. As shown in FIG. 6B, the input gear assembly 5 includes a bearing 36 arranged between the support plate 4 and the output shaft 9. The bearing 36 can be configured to center the support plate 4 relative to the output shaft 9. A bearing 37, which may be a thrust bearing, can be arranged between an axial end of the support plate 4 and the output gear 12. This bearing 37 provides a thrust path between the input gear assembly 5 and the eccentric output assembly 13. A bearing 38 can be arranged between an axially extending flange of a base body 1b of the input gear 1 (i.e. base body 1b) and an input housing 40. In one aspect, the bearing 38 is axially secured via a shoulder formed on the base body 1b of the input gear. The input housing 40 can include a radially extending portion 40a and an axially extending portion 40b. A bearing 39, which may be a thrust bearing, is arranged between an axial end face of the base body 1b of the input gear 1 and the input housing 40. The thrust bearing 39 can be arranged against the radially extending portion 40a and the axial end of the base body 1b of the input gear 1.

The input housing 40 is secured by at least one fastener 41 to a seal plate 42 to form an input housing assembly 43. In one aspect, the seal plate 42 is formed as stamped sheet metal. The at least one fastener 41 can include a plurality of rivets, in one embodiment. As shown in FIG. 3, at least one fastener 44 is configured to connect the OCV housing assembly 15 to the input housing assembly 43. The at least one fastener 44 can include a plurality of bolts, in one aspect. The at least one fastener 44 extends between and connects the OCV housing assembly 15, the seal plate 42, and the input housing 40.

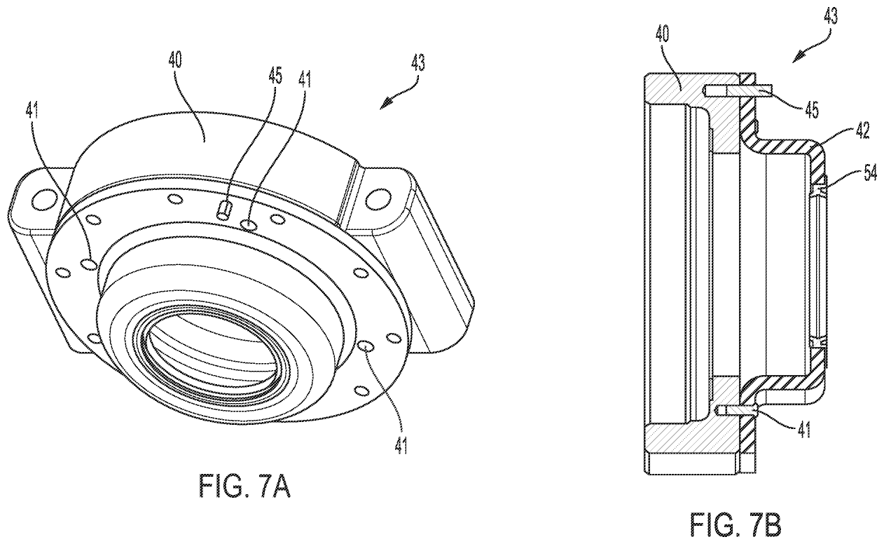

The input housing assembly 43 is shown in more detail in FIGS. 7A and 7B. As shown in FIGS. 7A and 7B, at least one alignment element 45 can be provided that extends between the input housing assembly 43 and the OCV housing assembly 15. In one aspect, the at least one alignment element 45 includes a plurality of pins.

As shown in FIGS. 1 and 2, the OCV housing assembly 15, the output housing assembly 35, and the input housing assembly 43 are all configured to be secured to the engine via fasteners 46. The fasteners 46 can be bolts, in one arrangement.

FIG. 3 illustrates a lubrication path 47 configured to direct oil from the center of the output shaft 9 to various locations throughout the entire assembly. The lubrication path 47 can include an inlet on an axial end face (i.e. the leftmost end in FIG. 3) of the output shaft 9. For example, cross-drilled holes 48 can be provided in the output shaft 9 and can be configured to supply oil to any one or more of the bearings 28, 34, 36, 37, as well as the meshing or gear of the output gear 12.

Oil can also pass all the way through the output shaft 9, the holes 48, and any of the bearings, such that the oil reaches the input gear assembly 5, including the meshing or gear of gear 1 and other bearings, such as bearing 38.

At least one drain hole 49 can be provided in the OCV housing assembly 15 at an opposite axial end as an inlet for the lubrication path 47. The drain hole 49 is configured to drain oil from the lubrication path 47. The drain hole 49 connects with a recirculation port 50 of the OCV 14 at a cross-drilled fluid junction 51 before draining out of the OCV 14 back to an oil sump through a drain hole 52.

The recirculation circuit allows oil or hydraulic fluid to be provided back into the OCV 14 from the advance and retard ports 16, 17 due to torque fluctuations, and to drain out of the system.

As shown in FIGS. 3, 10A, 10B, a plurality of plugs 53 are configured to prevent oil leakage out of the OCV housing assembly 15 through the ends of the plurality of cross-drilled holes in the OCV housing assembly 15. A seal 54 can be provided that is mounted to the seal plate 42 and separates the pressurized retard oil chamber 19 from the rest of the assembly.

In one aspect, a method of assembling the phase adjuster 100 is provided. Multiple steps are described herein. One of ordinary skill in the art would understand that any one or more of the steps can be modified. Additionally, any one or more other steps may be required that are not explicitly described with respect to the method but are otherwise disclosed in this disclosure.

The phase adjuster 100 can be assembled by arranging the drive nut 7 and the spring 26 inside of the drive plate 3. The drive nut 7 is then compressed against the spring 26 while the at least one stop element 55 in the drive plate 3 is formed to capture the drive nut 7 within. The at least one stop element 55 can be formed by a simple deformation process. This step helps retain the drive nut 7 and prevents the drive nut 7 from falling out of the input gear assembly 5.

The output housing assembly 35 is then connected to the assembly by inserting the output shaft 9 into the helical gear 8 of the drive nut 7 until the output gear 12 engages with (i.e. bottoms out on) the thrust bearing 37 mounted to the support plate 4.

Next, a fastener 57, such as a bolt, and a retainer washer 56 are arranged on an axial end of the output shaft 9 to retain the output housing assembly 35 to the input gear assembly 5. The input housing assembly 43 is then engaged around and onto the bearings 38, 39 such that the input housing assembly 43 is supported on the input gear assembly 5. In one aspect, the central fastener 57 can be omitted and other fastening arrangements can be used.

The piston assembly 20 is then arranged inside of the seal plate 42 and onto the drive nut 7. At least a portion of the piston plate 21 (i.e. protrusion 25) is then deformed into the groove 7a in the drive nut 7 so that the drive nut 7 and the piston plate 21 remain connected. Finally, the OCV housing assembly 15 is bolted to the end of the input housing assembly 43.

One of skill in the art would understand from the present disclosure that the phase adjuster 100 could include any variety or type of rolling element bearings. For example, the thrust bearings and ball bearings could be replaced with angular contact ball bearings capable of handling radial and axial loads.

In another aspect, the OCV housing assembly 15 can be connected to a remainder of the phase adjuster via an internally recirculating valve.

The embodiments disclosed herein provides a cost-effective configuration that incorporates multiple stamped sheet metal components, which are more cost-effective and affordable than cast formed components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments that may not be explicitly described or illustrated.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

Input gear 1
Input gear threading 1a
Base body 1b
Fastener 2
Drive plate 3
Radially extending flange 3a
Axially extending portion 3b
Support plate 4
Radially extending flange 4a
Input gear assembly 5
Spline 6
Drive nut 7
Groove 7a
Radially outer spline 7b
Gear 8
Output shaft 9
Gear 10
Connection interface 11
Output gear 12
Output assembly 13
Control valve 14
OCV housing assembly 15
Advance port 16
Retard port 17
Advance chamber 18
Retard chamber 19
Piston assembly 20
Piston plate 21
Axially extending flange 21a
Radially extending flange 21b
Fastener 22
Clip seal plate 23
Seals 24, 24a, 24b
Protrusion 25
Spring 26
Retainer 27
Bearing 28
Thrust washer 29
Output housing 30a, 30b
Fastener 31
Opening 33
Bearing 34
Output housing assembly 35
Bearing 36
Thrust bearing 37
Bearing 38
Thrust bearing 39
Input housing 40
Radially extending portion 40a
Axially extending portion 40b
Fastener 41
Seal plate 42
Input housing assembly 43
Fastener 44
Alignment element 45
Fasteners 46
Lubrication path 47
Cross-drilled hole 48
At least one drain hole 49
Recirculation port 50
Junction 51
Drain hole 52
Plugs 53
Seal 54
Stop element 55
Retainer washer 56
Fastener 57

What is claimed is:

1. A phase adjuster for an internal combustion engine, the phase adjuster comprising:
an input gear assembly including an input gear threading and a base body;
a drive plate including a first radially extending flange connected to the base body, the drive plate having an axially extending portion including a spline configured to transmit torque to a drive nut;
a support plate including a second radially extending flange connected to the base body; and
at least one first fastener connecting the base body, the first radially extending flange, and the second radially extending flange.

2. The phase adjuster according to claim 1, wherein the drive plate and the support plate are formed from stamped sheet metal.

3. The phase adjuster according to claim 1, wherein the drive plate further comprises a stop element configured to limit axial movement of the drive nut.

4. The phase adjuster according to claim 1, further comprising the drive nut, wherein the drive nut includes a groove on a radially outer surface configured to engage with a piston assembly.

5. The phase adjuster according to claim 4, further comprising the piston assembly, wherein the piston assembly includes a piston plate having a protrusion configured to engage with the groove on the drive nut to provide a non-threaded connection between the piston assembly and the drive nut.

6. The phase adjuster according to claim 5, wherein the piston plate is formed from stamped sheet metal.

7. The phase adjuster according to claim 1, further comprising an output assembly, the output assembly comprising:
a first output housing and a second output housing connected via at least one second fastener; and
an output gear arranged radially inside of the second output housing.

8. The phase adjuster according to claim 1, wherein the input gear assembly includes an input housing supported on the base body via a first bearing and a second bearing, wherein the first bearing is axially supported against a shoulder of the base body, and the second bearing is a thrust bearing engaging an axial end face of the base body.

9. The phase adjuster according to claim 1, further comprising:
a seal plate and an input housing fixed to each other, the input housing being supported on the base body via a first bearing, the seal plate being formed from stamped sheet metal and partially defining a hydraulic fluid chamber;
a piston assembly including a piston plate; and
a seal arranged between the seal plate and the piston plate.

10. The phase adjuster according to claim 9, further comprising an oil control valve (OCV) housing assembly that is fixed to the seal plate and the input housing via at least one fastener.

11. A phase adjuster for an internal combustion engine, the phase adjuster comprising:
an input gear and an output gear;
a drive plate including a spline; and
a drive nut configured to transmit torque from the input gear to an output gear via engagement with the spline of the drive plate.

12. The phase adjuster according to claim 11, wherein the spline of the drive plate is configured to limit axial movement of the drive nut.

13. The phase adjuster according to claim 11, further comprising a piston plate, wherein the drive nut is engaged with the piston plate via a radial protrusion formed on the piston plate.

14. The phase adjuster according to claim 13, wherein the radial protrusion extends in a radially inward direction.

15. The phase adjuster according to claim 13, further comprising a seal arranged between a seal plate and the piston plate.

16. The phase adjuster according to claim 11, further comprising a piston assembly including:
a piston plate;
a seal plate secured to an axial end face of the piston plate;
a radially outer seal secured between the piston plate and the seal plate; and
a radially inner seal secured between the piston plate and the seal plate.

17. The phase adjuster according to claim 16, wherein the radially outer seal and the radially inner seal are each configured to engage with an oil control valve (OCV) housing assembly.

18. The phase adjuster according to claim 16, wherein the drive nut has a non-threaded connection with the piston plate.

19. The phase adjuster according to claim 16, wherein the piston plate is formed from stamped sheet metal.

20. The phase adjuster according to claim 11, wherein the drive plate is formed from stamped sheet metal.
